(19) United States
(12) Patent Application Publication
(10) Pub. No.: US 2018/0165583 A1
(43) Pub. Date: Jun. 14, 2018

(54) CONTROLLING SYSTEMS BASED ON VALUES INFERRED BY A GENERATIVE MODEL

(71) Applicant: Microsoft Technology Licensing, LLC, Redmond, WA (US)

(72) Inventors: John P. Guiver, Saffron Walden (GB); John M Winn, Cambridge (GB); Sebastian Blohm, Cambridge (GB)

(21) Appl. No.: 15/378,361

(22) Filed: Dec. 14, 2016

(51) Int. Cl. G06N 5/04; G06N 7/00

(52) U.S. Cl. CPC G06N 5/04; G06N 7/005

(57) ABSTRACT

Time-stamped activity data, indicative of detected user activity, is received. A generative model explicitly models the rates of certain actions during certain activities and infers values based on observed data corresponding to those activities. A control system generates control signals, based on the inferred values, to control one or more different controlled systems or subsystems.

### BACKGROUND

Computing systems are currently in wide use. Some computing systems are used to increase user productivity.

For instance, computing systems can include electronic mail (e-mail) computing systems that allow a user to perform e-mail functions. Such functions can include authoring and sending e-mail messages, receiving e-mail messages, sending and receiving attachments, organizing filters and folders, among a wide variety of other things. Other computing systems can include calendar or scheduling systems that allow a user to perform calendar and scheduling operations. For instance, the user can send and receive meeting requests, schedule appointments, arrange collaborative meetings, etc. There are also a wide variety of other computing systems that are used by users. Some such computing systems include document management systems, collaborative work environment systems, meeting systems (such as online meeting systems), among others.

It can be difficult for users to interact with one another using such computing systems. For instance, it can be difficult for a user to reliably know the schedule or habits of another user, and therefore to use the computing systems in order to perform work. By way of example, it can be difficult for a user to know whether other users are available to meet at a given time, whether they have recently been on vacation, how likely other users are to attend a meeting that the user is attempting to schedule, etc.

Some current computing systems allow a user to visualize explicit information only. That is, such computing systems surface existing data and allow a user to look through it in an attempt to make a decision. For instance, one such computing system may generate a dialog as part of a user experience for creating a meeting. In the dialogue, a potential attendee's availability can be reviewed. The only information that the user is provided with, explicitly, is when the potential attendees are available. Some other current computing systems aggregate event counts for different time frames. However, the accuracy of such information is dependent on the frequency and volume with which a given user uses the system. If a user uses the system frequently, or for a relatively large number of operations, then the aggregated event counts may be reasonable. However, if the opposite is true, and the data for a given user is sparse, then the aggregated event counts are unreliable.

The discussion above is merely provided for general background information and is not intended to be used as an aid in determining the scope of the claimed subject matter.

### SUMMARY

Time-stamped activity data, indicative of detected user activity, is received. A generative model explicitly models the rates of certain actions during certain activities and infers values based on observed data corresponding to those activities. A control system generates control signals, based on the inferred values, to control one or more different controlled systems or subsystems.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing one example of data cleaning logic, in more detail.

FIG. 3 is a block diagram showing one example of a generative model, in more detail.

FIG. 3A illustrates one example of hierarchical declarative variable connection logic in the generative model.

FIG. 4 is a block diagram showing one example of a control system, in more detail.

FIG. 5 is a flow diagram illustrating one example of the operation of the data cleaning logic in generating data on which the generative model operates.

FIG. 6 is a flow diagram illustrating one example of the operation of the generative model.

FIG. 7 is a flow diagram illustrating one example of the operation of a control system.

FIG. 8 is a block diagram showing one example of the architecture illustrated in FIG. 1, deployed in a cloud computing architecture.

FIGS. 9-11 show examples of mobile devices that can be used in the architectures shown in the previous figures.

FIG. 12 is a block diagram showing one example of a computing environment that can be used in the architectures shown in the previous figures.

### DETAILED DESCRIPTION

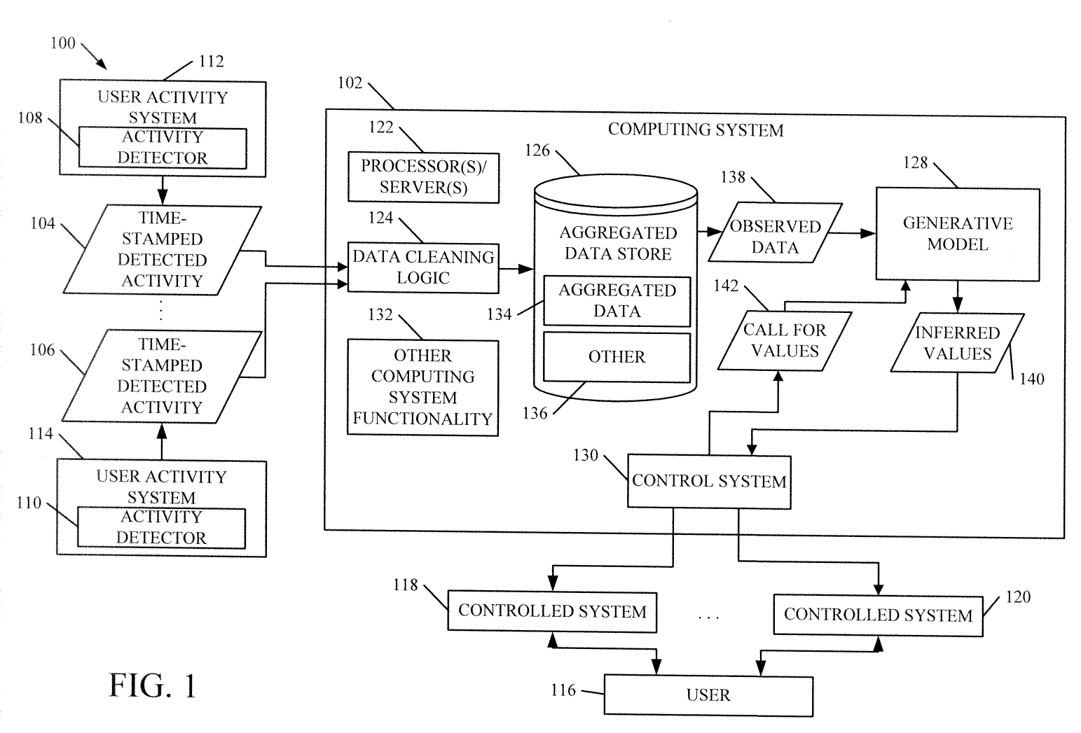

FIG. 1 is a block diagram showing one example of a computing system architecture 100. Architecture 100 illustratively includes computing system 102 that receives time-stamped detected activity data 104-106 from a variety of different user activity detectors 108-110 in user activity systems 112-114. In one example, the user activity systems 112-114 can be any systems in which a particular user 116 can take action. For instance, systems 112-114 can be calendar systems, meeting systems, e-mail systems, document management systems, social network systems, among a wide variety of other systems. The activity detectors 108-110 illustratively detect user activity within the corresponding system. Therefore, for instance, if the user activity system is an e-mail system, then the activity detector may illustratively detect when the user interacts with the e-mail system, such as by opening or viewing e-mail messages, authoring e-mail messages, etc. Other examples are described below.

Computing system 102 is also shown generating outputs that control controlled systems 118-120. The controlled systems 118-120 can, themselves, be similar to the user activity systems 112-114, or they can be different. For instance, computing system 102 can include a digital assistant that provides an output indicative of suggested user actions in different systems or indicating values for actions. It can be used to control a scheduling system to generate a meeting request. It can be used to control an electronic mail system to send an electronic mail message. It can be used to control a document management system to share various documents or perform other document management operations. It can be used to control a cellular communication device (such as a mobile device), to notify a user of certain things, to silence a ringer if the user is likely in a meeting, or to perform a wide variety of other functions on the mobile device. These are examples only, and controlled systems 118-120 can take a wide variety of other forms.

In the example shown in FIG. 1, computing system 102 illustratively includes one or more processors or servers 122, data cleaning logic 124, aggregated data store 126, generative model 128, control system 130, and it can include a wide variety of other computing system functionality 132. Before describing the overall operation of computing system 102 and architecture 100 in more detail, a brief description of some of the items in computing system 102, and their operation, will first be provided.

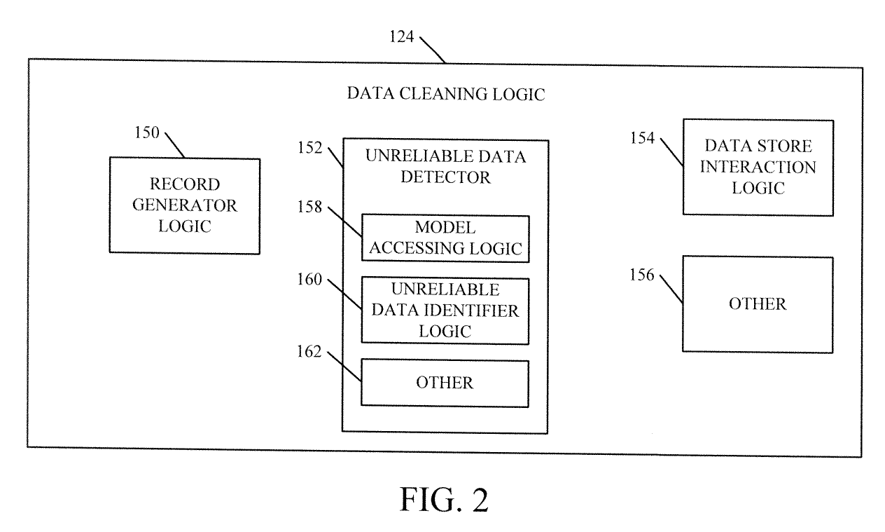

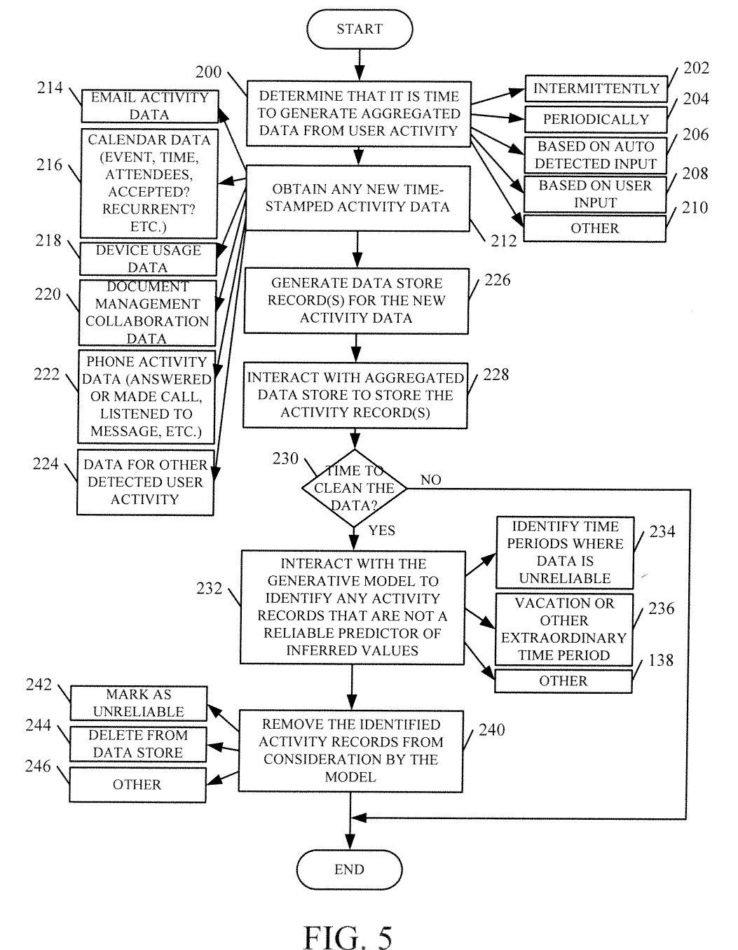

Data cleaning logic 124 illustratively receives the time-stamped detected activity data 104-106 generated by the activity detectors 108-110. It can perform various data cleaning operations to increase the reliability of that data. For instance, where the data is collected during a time period that is unreliable or extraordinary (as will be discussed in more detail below), then that data can be removed from further processing. Where the data is unreliable in representing normal user activity patterns for other reasons, it can be removed as well. Examples of this are described below with respect to FIGS. 2 and 5. Eventually, data cleaning logic 124 creates data records indicative of the time-stamped detected activity data 104-106 and stores those records in aggregated data store 126 as aggregated data 134. Aggregated data store 126 can store other items 136 as well.

Generative model 128 can be any of a variety of different models. In one example, it is a Bayesian hierarchical model which can receive observed data 138 (such as various data items from aggregated data store 126 or from a call by another service or system) and generate inferred values 140, from the observed data 138. The inferred values 140 can be output in response to a call for values 142 from control system 130. In response, control system 130 illustratively generates control signals to control the controlled systems or subsystems 118-120.

The inferred values 140 can take a wide variety of different forms as well. For instance, they may be indicative of hours during a given day or week that are normal working hours for a user from which the activities were detected. The inferred values 140 can represent normal working days for the user, they can represent exceptional days (such as vacation days or other unusual days) for the user, among other things. The generative model 128 is hierarchical, which increases its performance based on sparse data. As will be described in more detail below, because of the hierarchical nature of the model, inferences can be drawn for certain time periods (such as days of the week, hours of the day, etc.) based upon observed data for other time periods (such as for other days of the week, other hours of the day, etc.).

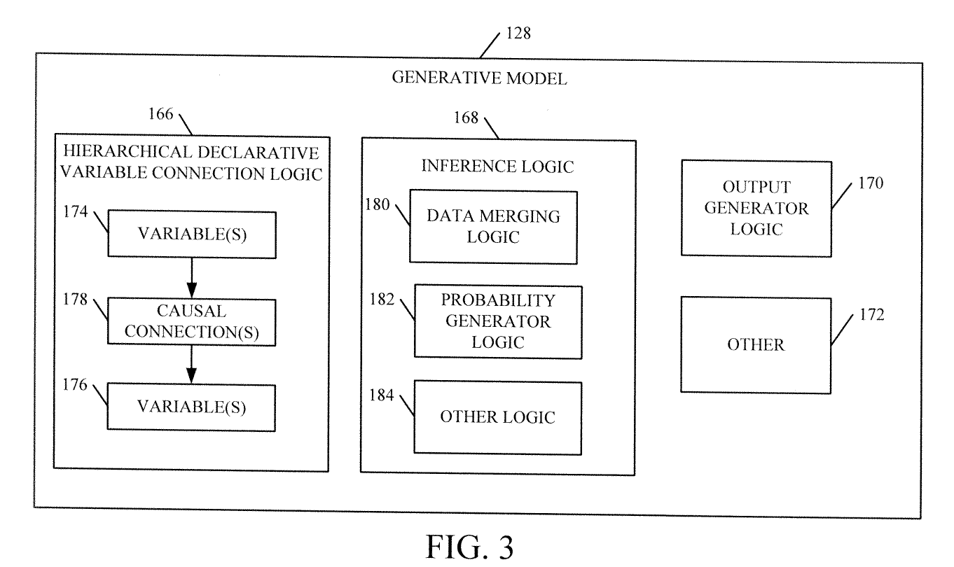

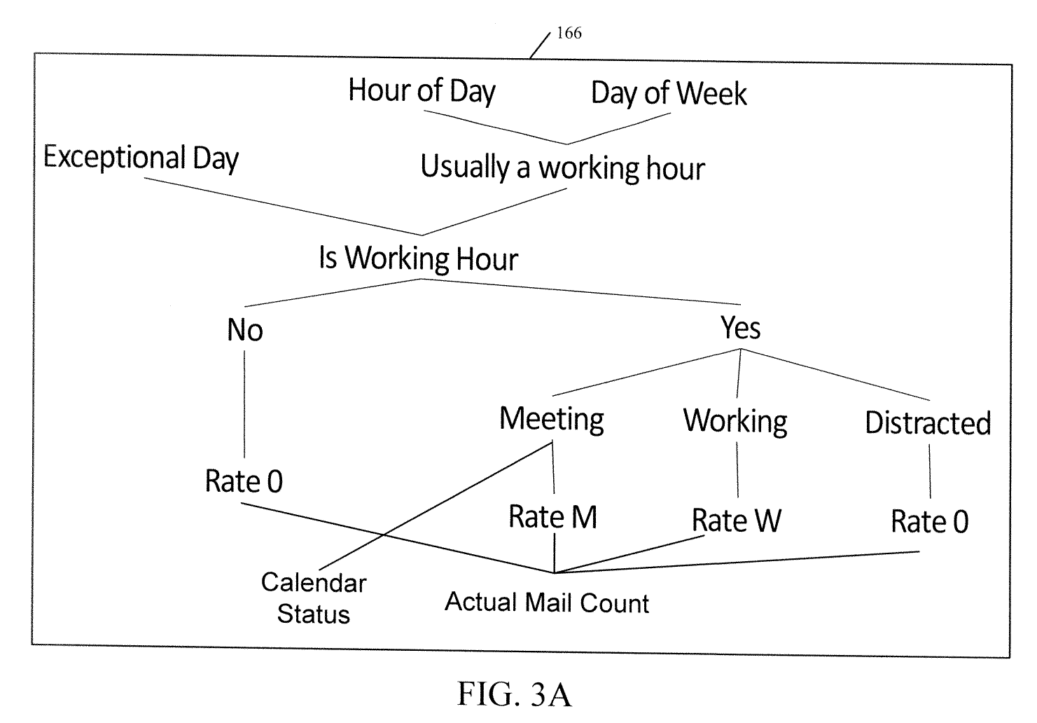

For example, assume that observed data is obtained for the hour of 9:00 AM to 10:00 AM on Monday, and the observed data indicates that that hour is a normal working hour for a particular user. That information can be used to infer information about the same time period on Tuesday, or for another time period (e.g., 10:00 am-11:00 am) on the same day (e.g., Monday). Therefore, the hierarchical nature of the model allows observed data for certain days of the week to be used to infer values on other days of the week. It also allows data for certain hours of a day to be used to infer values for other hours of the day. This allows the model to work well, and reliably, even when the data for certain portions of a user's schedule is relatively sparse. This is described in more detail below with respect to FIG. 3.

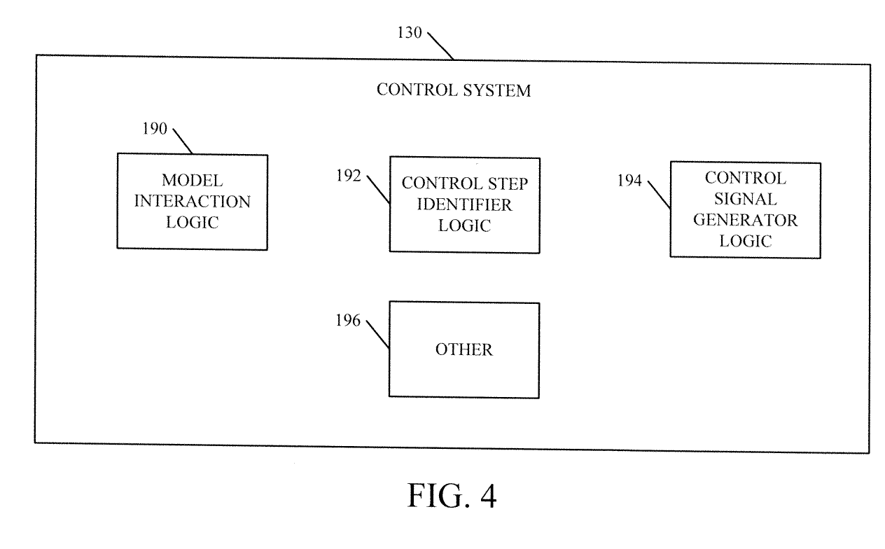

The control signals generated by control system 130 may vary based upon the particular controlled systems 118-120, which are being controlled. In one example, control system 130 can generate the call for values 142 to generative model 128 and, in response, receive the inferred values. The call may be based upon a user interaction by user 116. For instance, user 116 may be attempting to schedule a meeting with other users, and therefore the call 142 may be indicative of whether the other user is available at a certain time, whether the other user will likely accept the meeting request, etc. In addition, the call may be generated automatically. For instance, control system 130 may be controlling a controlled system 118 which comprises a mobile device for user 116. System 130 may generate a call to attempt to identify whether user 116 is in a meeting. If so, control system 130 can automatically generate a control signal to silence the ringer on the user's mobile device. Control system 130 will also be described in greater detail below with respect to FIG. 4.

FIG. 2 is a block diagram showing one example of data cleaning logic 124 in more detail. Logic 124 can exclude some signals from consideration. For instance, it can exclude the “mail read” signal because reading may take very little time. It may also exclude mail signals that are from relatively old mail messages (such as those older than six months or other messages). In the example shown in FIG. 2, data cleaning logic 124 illustratively includes record generator logic 150, unreliable data detector 152, data store interaction logic 154, and it can include other items 156. Unreliable data detector 152 can, itself, include model accessing logic 158, unreliable data identifier logic 160, and it can include other items 162.

Briefly, and as will be described in greater detail below with respect to FIG. 5, record generator logic 150 illustratively receives the time-stamped detected activity data 104-106 and generates one or more data store records for storing the data in aggregated data store 126. Data store interaction logic 154 can interact with aggregated data store 126 to store the data records generated by logic 150, as aggregated 134 (which can be aggregated on a per-user basis, a per-group basis, a per-organization basis, etc.). At some point, unreliable data detector 152 determines that it is time to clean the data stored in data store 126. When that occurs, model accessing logic 158 can access generative model 128. In doing so, it can make a call to the model to determine whether any of the aggregated data was taken during a time which may spawn unreliable data. For instance, if the activity detectors detect certain e-mail activity of a user, during a certain time period, but model 128 generates inferred values that strongly indicate that that time period was a time period during which the user was on vacation, then the activity data collected during that time may be unreliable with respect to the user's normal schedule. Therefore, in one example, model accessing logic 158 accesses generative model 128 to determine whether any aggregated data 134 may be unreliable, in this way. Generative model 128 may return time periods that are identified as extraordinary (such as when the user is on vacation, on sick leave, etc.) and thus indicating that data detected during those time periods may be unreliable. Unreliable data identifier logic 160 then identifies any data records in aggregated data 134, for this user, that are indicative of user activity during that time period. These data records will be identified as unreliable, and they can be removed from the aggregated data store or marked as unreliable, etc.

FIG. 3 is a block diagram showing one example of generative model 128, in more detail. Generative model 128 illustratively includes hierarchical declarative variable connection logic 166, inference logic 168, output generator logic 170, and it can include other items 172. Hierarchical declarative variable connection logic 166 illustratively connects various variables 174-176 with causal connections 178. Some examples of this will be discussed below with respect to FIG. 3A. Suffice it to say, for now, that when variables 174 are observed variables, then the hierarchical declarative variable connection logic 166 can be used to infer values for variables 176. When variables 176 are the observed variables, then logic 166 can be used to infer values for variables 174.

Inference logic 168 can, in one example, operate by obtaining a prior belief of variable value distributions, passing messages among the causal connections between variables and updating the belief based on the result of passing the messages among the variables. It can include merging logic 180, probability generator logic 182, and it can include other logic 184. Data merging logic 180 illustratively merges data from different sources. For instance, when model 128 is generating an inferred value indicative of a likelihood that a user is available, data merging logic 180 may merge data detected based on the user activity, with data from the user's calendar to indicate that it is highly likely that a user is in a meeting during a given time period, etc. For instance, it may be that the user uses his or her e-mail system much less frequently during meetings. Therefore, if the observed mail count indicative of user activity within his or her e-mail system is relatively low for this user, then data merging logic 180 can access the user's calendar data to confirm that the user is, indeed, in a meeting.

Probability generator logic 182 illustratively generates a probability distribution over all possible values of a variable. For instance, all of the possible inferred values may be uncertain. However, if there is less uncertainty in a given variable, one value for that variable will have a relatively high probability relative to the other values.

Control system 130 (depicted in more detail below in FIG. 4) can be configured to take various actions based not only on the inferred values, but on the probability that the inferred values are correct. For instance, before generating a control signal to automatically turn off the ringer on a user's mobile device, it may be that control system 130 will need to confirm that the inferred value 140 indicates that the user is in a meeting, and that the inferred value has a very high probability of being accurate. Control system 130 can take other actions simply based on the inferred values 140, or based on the inferred values 140, even though they have a relatively low probability. All of these configurations are contemplated herein.

Output generator logic 170 generates an output indicative of the inferred values, and the corresponding probability that those inferred values are correct. It can provide this to control system 130, or to data cleaning logic 124 (when it is performing a data cleaning operation as described below) or in other ways.

FIG. 3A shows one example of hierarchical declarative variable model (or connection logic) 166. The words or phrases shown in FIG. 3A are the variables, some of which may be inferred and some of which may be observed. The lines between the words or phrases indicate a causal relationship, or a hierarchical dependency where variables depicted below other variables they are connected to causally depend on those (and not any others). For instance, as shown in FIG. 3A, a variable indicating whether a given hour of a day is usually a working hour depends on a variable indicative of the particular hour of the day and are indicative of the day of the week. The variable indicating that the hour is actually a working hour is dependent upon a variable indicative of whether the hour is usually a working hour and a variable indicative of whether the present day is an exceptional day for this user. The variables indicative of whether the user is in a meeting, is working, or is distracted, are based on a variable indicative of whether the present hour is a working hour. Rate R, rate M, rate W and rate 0 are rates of activity that can be inferred (while the number of activities in a given time period can be observed) when the user is in a meeting, when the user is working, and when the user is distracted. For instance, assume that the rates are rates of activity on the user's e-mail system. When the user is in a meeting, it may be that the user's activity represented by rate M is relatively low. When the user is working, the rate of activity represented by rate W may be relatively high. When the user is distracted, the rate is represented by rate 0, and that rate may be very close to zero. Similarly, if the present working hour is not a working hour, then the observed or inferred activity rate for the user may also be rate 0.

The calendar status and actual mail count in logic 166 illustratively represent observed values. For instance, the calendar status may directly indicate whether the user has a meeting scheduled at a particular time on a particular day. The actual mail count may be used to determine whether the mail count more closely corresponds to any of the given rates discussed above. Thus, given an actual mail count (or mail activity count) and the user's calendar status, model 128 can be used to infer whether the user is currently in a meeting, is working, or is distracted. In addition, given an hour of the day and a day of the week, and also given an inferred or observed value as to whether the present day is an exceptional day, model 128 can be used to output an inferred value indicative of whether a given hour is actually a working hour. Logic 166 can be used by model 128 in other ways as well, and those discussed herein are discussed for the sake of example only.

FIG. 4 is a block diagram showing one example of control system 130, in more detail. In the example shown in FIG. 4, control system 130 illustratively includes model interaction logic 190, control step identifier logic 192, control signal generator logic 194, and it can include other items 196. Model interaction logic 190 can be used to interact with generative model 128. For instance, logic 190 can be used to generate a call for values 142. It can do this in response to a user input, or automatically, as briefly discussed above. It can also receive the inferred values 140 and corresponding probabilities, from generative model 128. Control step identifier logic 192 then identifies any control steps which need to be executed or performed, based upon the inferred values and corresponding probabilities. For instance, depending on the type of controlled system 118-120 that is being controlled, the steps may be different. If control step identifier logic 192 is attempting to automatically control a user's mobile device, then the steps may be a first set of steps. On the other hand, if the controlled system is a meeting system and control system 130 is attempting to automatically schedule a meeting, then the set of control steps identified will be a different set. Control signal generator logic 194 generates the control signals based upon the identified control steps, in order to perform those control steps in the particular controlled system 118-120 that is being controlled.

FIG. 5 is a flow diagram illustrating one example of the operation of architecture 100, in generating aggregated data 134, upon which generative model 128 can operate. Data cleaning logic 124 first determines that it is time to generate aggregated data from the various user activity that is being detected. This is indicated by block 200 in the flow diagram of FIG. 5. This can be done intermittently 202 or periodically 204. For instance, data cleaning logic 124 can aggregate time-stamped detected activity data 104-106 from the various detectors 108-110, for a given user (or a set of users, etc.) intermittently, or on a periodic basis. It can be done semi-continuously, or on a continuous basis as well.

Further, data cleaning logic 124 can determine that it is time to generate aggregated data based upon an automatically detected input 206 or any time a time-stamped detected data activity 104-106 is provided to it. Logic 124 can also be expressly requested by the user (or an administrative user) to generate aggregated data records based on user activity. All of these and other ways of determining that it is time to generate aggregated data records are contemplated herein.

When it is time to generate aggregated data 134, data cleaning logic 124 obtains any new time-stamped activity data 104-106. Obtaining this data is indicated by block 212 in the flow diagram of FIG. 5. Again, the activity data can be e-mail activity data 214, calendar activity data 216 (which may include an event, a time of the event, attendees at the event, those that have accepted and declined, whether the event is a recurrent event, etc.). It can include device usage data 218 (such as when and how a user is using a particular device). It can include document management/collaboration data 220 indicative of user activities in a document management or collaboration system. It can include phone activity data 222, such as when a user answered or made a call, listened to a message, etc. It can include a wide variety of data for other detected user activity 224, as well.

Once the data is received, the record generator logic 150 in data cleaning logic 124 illustratively generates a data store record for each new item of activity data. This is indicated by block 226. In one example, the data may be simply a single line indicating the identity of the person who performed the activity, and a description or identifier for the particular activity. This is only one example of a data record and many others could be used as well.

Data store interaction logic 154 then interacts with aggregated data store 126 to store the activity records as aggregated data 134 in data store 126. This is indicated by block 228 in the flow diagram of FIG. 5.

At some point, unreliable data detector 152 will determine that it is time to clean the aggregated data 134 in data store 126. This is indicated by block 230. When it is determined that it is time to clean the data, then model accessing logic 158 illustratively interacts with the generative model 128 to identify any activity records that may not be a reliable predictor of inferred values. This is indicated by block 232. For instance, model accessing logic 158 can make a call to generative model 128 to identify time periods where the collected data may be unreliable. This is indicated by block 234. It may request model 128 to identify vacation or other extraordinary time periods where the user activity may not be normal for this user. This is indicated by block 236. It may access the model to obtain other values indicative of unreliable data in other ways as well. This is indicated by block 238.

Unreliable data identifier logic 160 then identifies any data records that were taken during those time periods, or that were otherwise identified as being unreliable, and removes the identified activity records from consideration by model 128 in subsequent operations. This is indicated by block 240 in the flow diagram of FIG. 5. In one example, the data can be maintained but marked as unreliable for certain operations. This is indicated by block 242. In another example, the data records can be deleted from the data store 126. This is indicated by block 244. In still other examples, the data can be quarantined or treated in other ways as well. This is indicated by block 246. Generative model 128 is then trained to model user activity based on the aggregated data 134. The variables and causal links, for instance, can be trained, as can the associated probabilities.

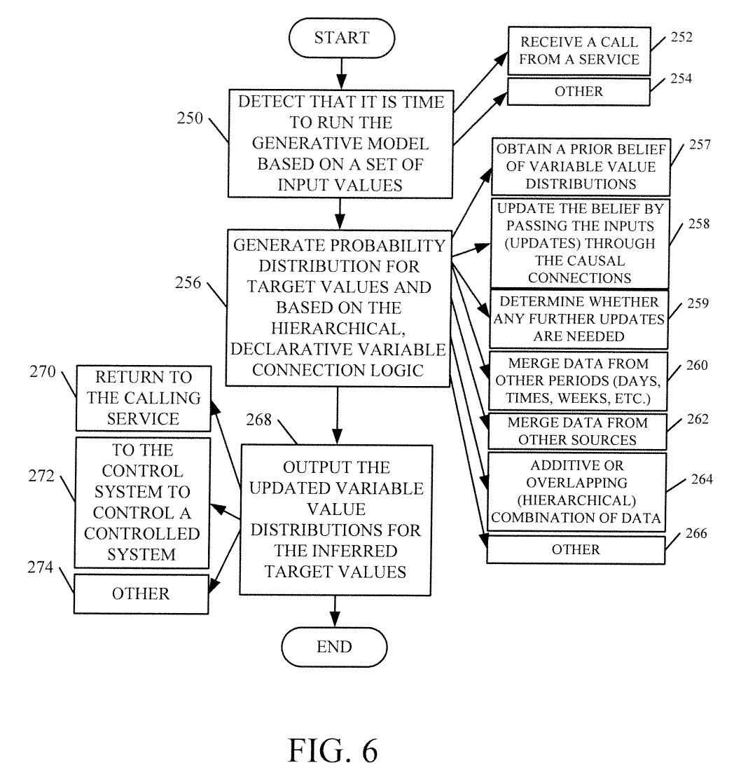

FIG. 6 is a flow diagram illustrating one example of the operation of model 128 in generating inferred values based upon model behavior, modeled from the observed values obtained from aggregated data store 126. Generative model 128 first detects that it is time to run the generative model based on a set of input values (or updates). This is indicated by block 250 in the flow diagram of FIG. 6. In one example, it receives a call, with a set of input values, from a service or other system (such as from control system 130, from data cleaning logic 124, or from a remote service or a remote computing system). Receiving a call in this way is indicated by block 252. It can detect that it is time to run the model in other ways as well, and this is indicated by block 254.

Generative model 128 then generates inferred target values 140 and corresponding probabilities, by using the hierarchical, declarative variable connection logic 166. Generating the inferred target values is indicated by block 256 in the flow diagram of FIG. 6. In one example, generative model 128 obtains a prior belief of variable value distributions, such as those determined during a previous operation. This is indicated by block 257. It then passes the inputs (or updates) through the causal connections 178 in logic 166. This is indicated by block 258. It then determines whether any further updates are needed. This is indicated by block 259 in FIG. 6. Again, the causal corrections can be generated from merged data, so the logic can handle sparse data reliably. Thus, data merging logic 180 can merge data from other periods (such as days, times, weeks, etc.) in generating the causal connections. This is indicated by block 260. It can also merge data from other sources (such as from the user's calendar, etc.). This is indicated by block 262. It can use an additive or overlapping (hierarchical) combination of data, as discussed above with respect to FIG. 3A. This is indicated by block 264 in the flow diagram of FIG. 6. It can generate the inferred target values in other ways as well, and this is indicated by block 266.

Output generator logic 170 then outputs the updated variable value distribution for the inferred target values 140. This is indicated by block 268. They can be returned to the calling service as indicated by block 270. They can be output to control system 130 for controlling a controlled system or subsystem 118-120. This is indicated by block 272. The inferred target values can be output in other ways as well, and this is indicated by block 274.

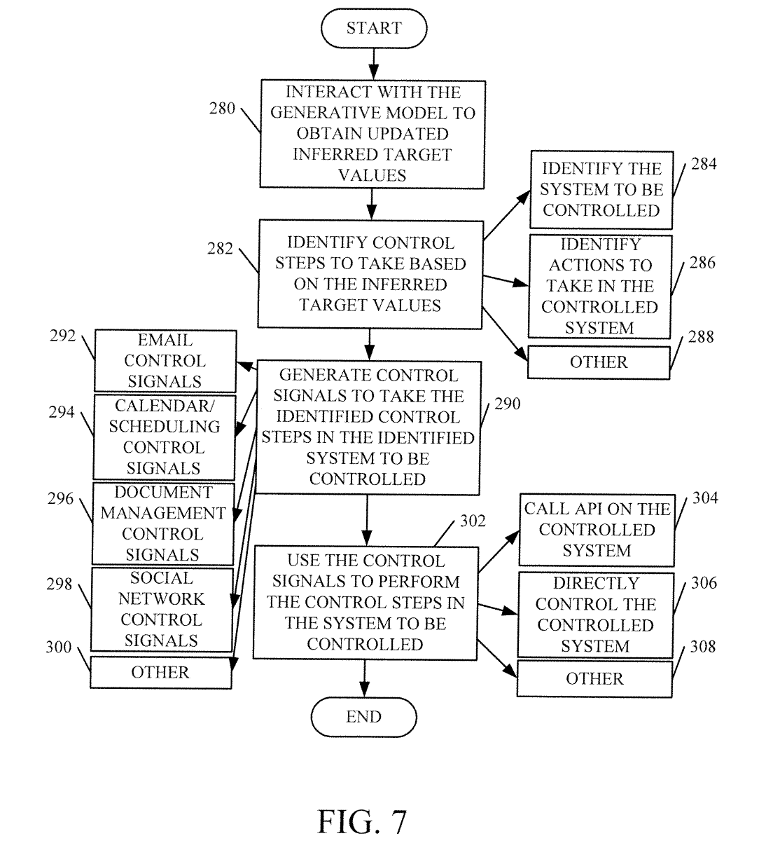

FIG. 7 is a flow diagram illustrating one example of the operation of control system 130, in generating control signals to control one or more controlled systems or subsystems 118-120. Model interaction logic 190 first interacts with the generative model 128 to obtain the inferred target values 140. This is indicated by block 280 in the flow diagram of FIG. 7. By way of example, this can be done in response to a user request for values, based on an automatic request for values, or in other ways. Once the inferred target values 140 are obtained, control step identifier logic 192 identifies any control steps to take based on the inferred target values. This is indicated by block 282. For instance, it can identify the particular controlled system or subsystem 118-120 that is to be controlled based on the inferred values. This is indicated by block 284. It can identify actions to take in the controlled system or subsystem, as indicated by block 286. It can identify control steps in other ways as well, and this is indicated by block 288.

Control signal generator logic 194 then generates control signals to take the identified control steps in the identified system or subsystem to be controlled. This is indicated by block 290 in the flow diagram of FIG. 7. In doing so, it can generate control signals in an integrated way to control the controlled system. It can generate a call to an application programming interface (API) exposed by the control system, or it can control the controlled system in other ways. The control signals can be generated in different ways, based upon the particular controlled system or subsystem to be controlled. Thus, they can be e-mail control signals 292 where the controlled system is an e-mail system. They can be calendar or scheduling control signals 294 where the controlled system is a calendar or scheduling system. They can be document management system control signals 296 where the controlled system is a document management system. They can be social network control signals 298 where the controlled system is a social network system. They can be a wide variety of other control signals 300 as well.

Control signal generator logic 194 then uses the control signals to perform the control steps in the system to be controlled. This is indicated by block 302. As mentioned above, this can be a call to an API exposed by the controlled system as indicated by block 304. It can be control signals that directly control the controlled system as indicated by block 306, or the control can be performed in other ways as well, and this is indicated by block 308.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

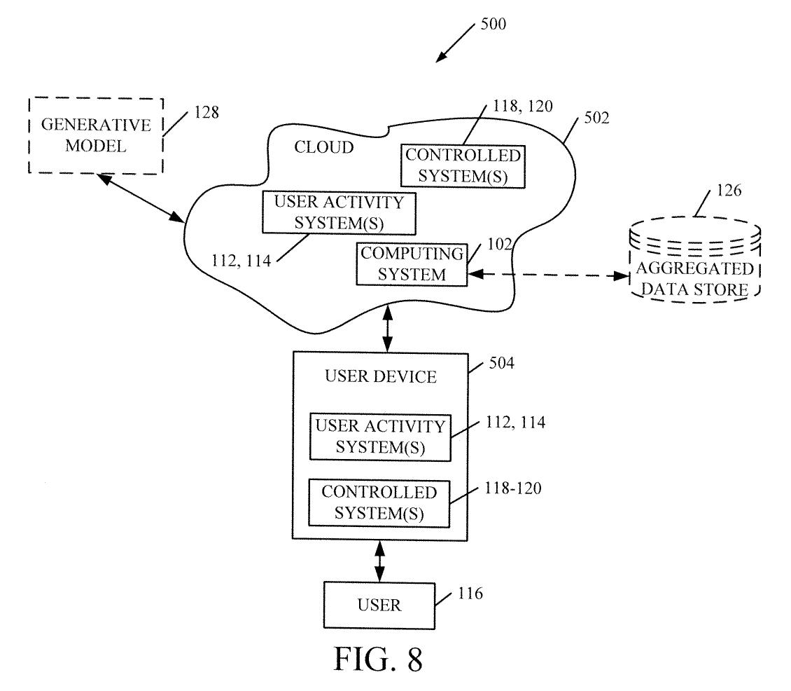

FIG. 8 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 8, some items are similar to those shown in FIG. 1 and they are similarly numbered. FIG. 8 specifically shows that computing system 102, user activity systems 112-114 and controlled systems 118-120 can be located in cloud 502 (which can be public, private, or a combination where portions are public while others are private). Therefore, user 116 uses a user device 504 (that can also include user activity systems 112-114 and controlled systems 118-120) to access those systems through cloud 502.

FIG. 8 also depicts another example of a cloud architecture. FIG. 8 shows that it is also contemplated that some elements of architecture 100 can be disposed in cloud 502 while others are not. By way of example, data store 126 can be disposed outside of cloud 502, and accessed through cloud 502. In another example, generative model 128 can be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

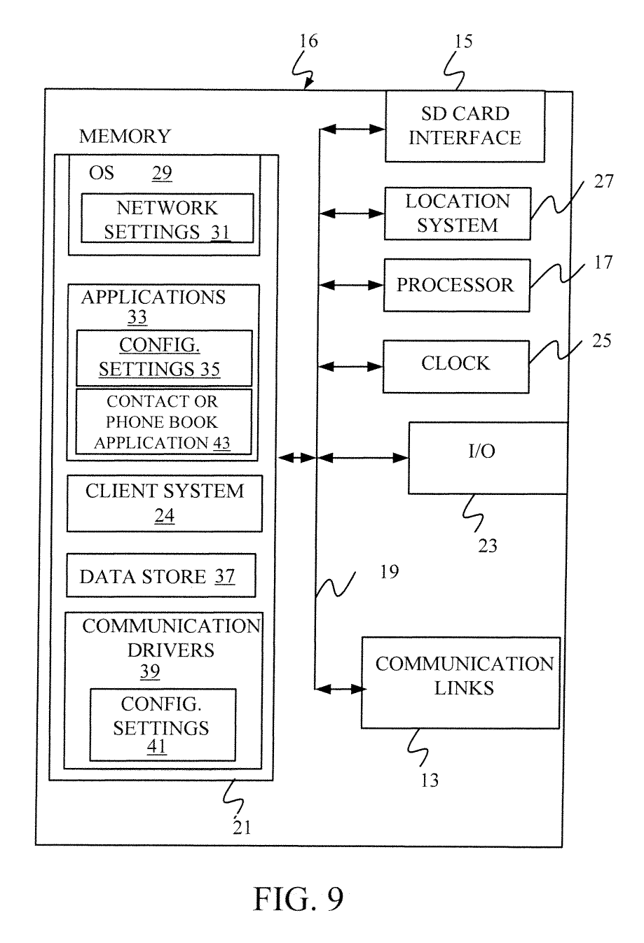

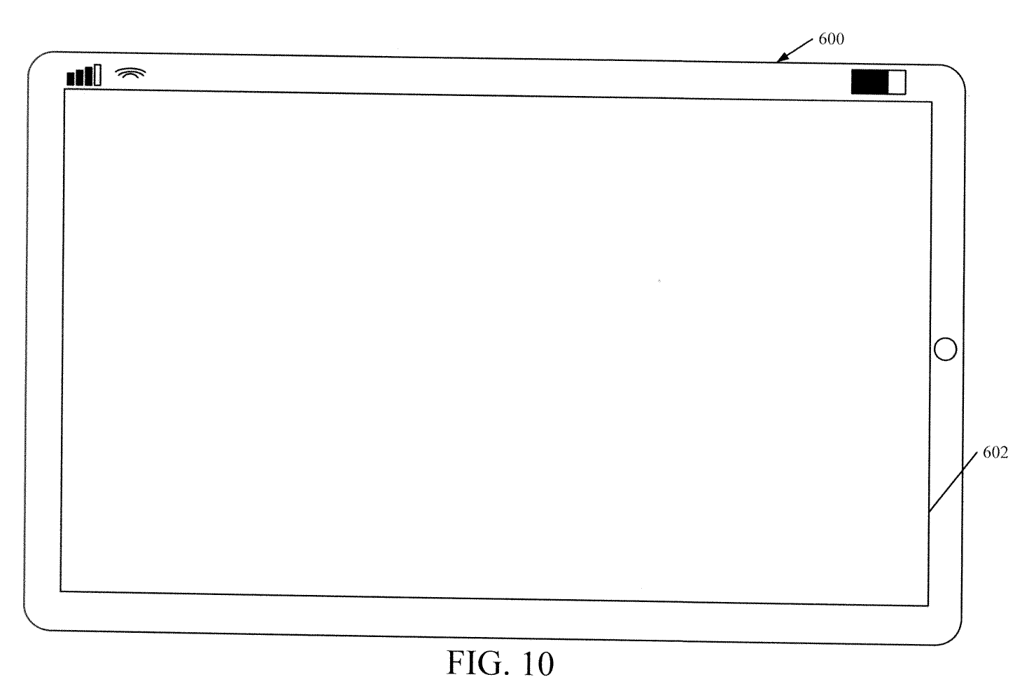

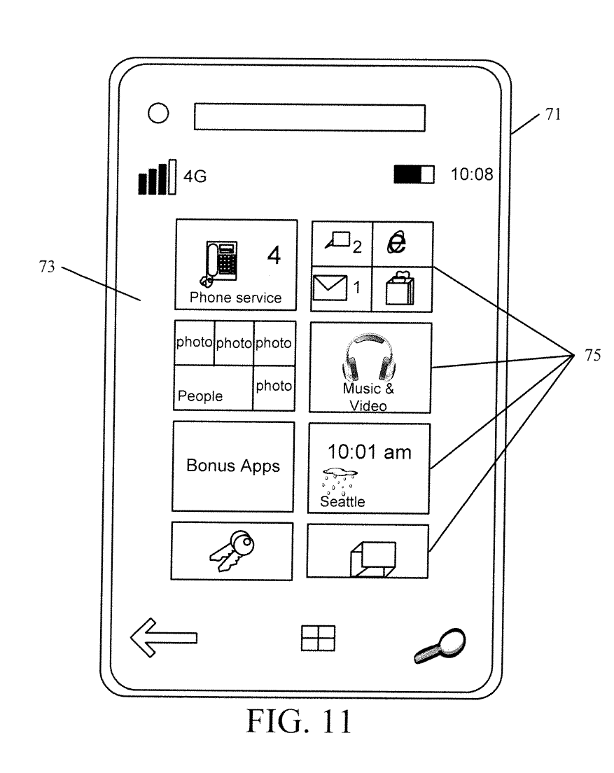

FIG. 9 is a simplified block diagram of one illustrative example of a handheld or mobile computing device that can be used as a user's or client's hand held device 16, in which the present system (or parts of it) can be deployed. FIGS. 10-11 are examples of handheld or mobile devices.

FIG. 9 provides a general block diagram of the components of a client device 16 that can run components of architectures 100 or 500 or that interacts with architectures 100 or 500, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers 122 or those on user device 504) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of the various systems. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 10 shows one example in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 11 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

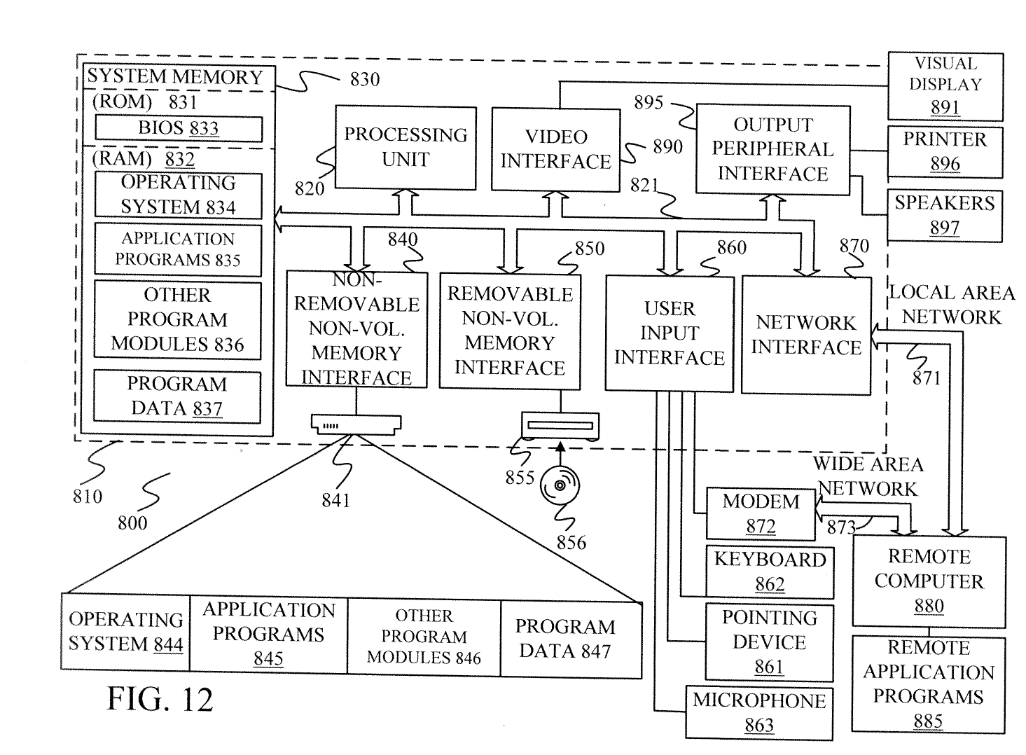

FIG. 12 is one example of a computing environment in which architecture 100, or parts of it, (for example) can be deployed. With reference to FIG. 12, an example system for implementing some embodiments includes a general-purpose computing device in the form of a computer 810. Components of computer 810 may include, but are not limited to, a processing unit 820 (which can comprise processors or servers 122 or those on user device 504 or other devices or systems), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a hierarchical generative model that receives a call for an inferred value of a variable and accesses inference logic that consumes user activity data including email activity data indicative of time-stamped, detected user activity in an electronic mail (email) system, and generates the inferred value indicative of a working characteristic of the user; and

a control system that receives the inferred value and generates a control signal to control a controlled system based on the inferred value.

Example 2 is the computing system of any or all previous examples wherein the hierarchical generative model comprises:

hierarchical declarative variable connection logic configured with variables connected to one another through causal connections based on the email activity data.

Example 3 is the computing system of any or all previous examples wherein the hierarchical generative model comprises:

inference logic configured to receive the call for the inferred value, including an input variable, and to apply the input variable to the hierarchical declarative variable connection logic to identify the inferred value.

Example 4 is the computing system of any or all previous examples wherein the inference logic comprises:

probability generator logic configured to generate a probability distribution for values corresponding to the variable.

Example 5 is the computing system of any or all previous examples wherein the hierarchical generative model comprises a hierarchical Bayesian model.

Example 6 is the computing system of any or all previous examples wherein the hierarchical declarative variable connection logic is configured with a value for a working hour variable, indicative of whether a given hour is a working hour for the user, being dependent on a value for a usual working hour variable, indicative of whether the given hour is usually a working hour for the user, and a value for an exceptional day variable, indicative of whether a given day is a working day for the user.

Example 7 is the computing system of any or all previous examples wherein the hierarchical declarative variable connection logic is configured with the value for the usual working hour variable being dependent on a value for an hour of day variable, indicative of a particular hour of a day corresponding to the given hour, and a value for a day of week variable, indicative of a particular day of week corresponding to the given day.

Example 8 is the computing system of any or all previous examples wherein the hierarchical declarative variable connection logic is configured with a value for a meeting variable being dependent on the value for the working hour variable and having an expected email activity rate indicative of a rate at which the user performs activities in the email system when the user is attending a meeting.

Example 9 is the computing system of any or all previous examples wherein the hierarchical declarative variable connection logic is configured with a value for a working variable being dependent on the value for the working hour variable and having an expected email activity rate indicative of a rate at which the user performs activities in the email system when the user is working.

Example 10 is the computing system of any or all previous examples wherein the hierarchical declarative variable connection logic is configured with a value for a distracted variable being dependent on the value for the working hour variable and having an expected email activity rate indicative of a rate at which the user performs activities in the email system when the user is distracted.

Example 11 is the computing system of any or all previous examples wherein the inference logic comprises:

data merging logic configured to combine the email activity data with other activity data from another source to generate the inferred value.

Example 12 is the computing system of any or all previous examples and further comprising:

data cleaning logic configured to receive time-stamped detected activity data indicative of user activity in a plurality of different systems and store the time-stamped detected activity data in a data store, for access by the hierarchical generative model.

Example 13 is the computing system of any or all previous examples wherein the data cleaning logic is configured to access the hierarchical generative model to identify a less reliable time period during which the time-stamped detected activity data is less reliable in representing a user activity pattern than at other time periods and to remove any time-stamped detected activity data, having a time stamp corresponding to the less reliable time period, from access by the hierarchical generative model.

Example 14 is a computer implemented method, comprising:

receiving a call for an inferred value of a variable, at a hierarchical generative model;

generating the inferred value, indicative of a working characteristic of a user, by accessing inference logic in the hierarchical generative model that consumes user activity data including email activity data indicative of time-stamped, detected user activity in an electronic mail (email) system; and

generating a control signal to control a controlled system based on the inferred value.

Example 15 is the computer implemented method of any or all previous examples and further comprising:

receiving time-stamped detected activity data indicative of user activity in a plurality of different systems;

storing the time-stamped detected activity data in a data store, for access by the hierarchical generative model.

Example 16 is the computer implemented method of any or all previous examples and further comprising;

accessing the hierarchical generative model to identify a less reliable time period during which the time-stamped detected activity data is less reliable in representing a user activity pattern than at other time periods; and

removing any time-stamped detected activity data, having a time stamp corresponding to the less reliable time period, from access by the hierarchical generative model.

Example 17 is the computer implemented method of any or all previous examples wherein receiving the call comprises receiving the call for the inferred value, including an input variable, and wherein accessing the inference logic in the hierarchical generative model comprises applying the input variable to hierarchical declarative variable connection logic, that hierarchically connects variables to one another with causal connections, to identify the inferred value.

Example 18 is the computer implemented method of any or all previous examples wherein generating the inferred value comprises:

generating a probability corresponding to the inferred value.

Example 19 is a computing system, comprising:

a hierarchical generative model that receives a call for an inferred value and accesses inference logic that consumes user activity data including email activity data indicative of time-stamped, detected user activity in an electronic mail (email) system, and generates the inferred value indicative of a working characteristic of the user;

data cleaning logic configured to receive time-stamped detected activity data indicative of user activity in a plurality of different systems and store the time-stamped detected activity data in a data store, for access by the hierarchical generative model and to access the hierarchical generative model to identify a less reliable time period during which the time-stamped detected activity data is less reliable in representing a user activity pattern than at other time periods and to remove any time-stamped detected activity data, having a time stamp corresponding to the less reliable time period, from access by the hierarchical generative model; and

a control system that receives the inferred value and generates a control signal to control a controlled system based on the inferred value.

Example 20 is the computing system of any or all previous examples wherein the hierarchical generative model comprises a hierarchical Bayesian model.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a hierarchical generative model that receives a call for an inferred value of a variable and accesses inference logic that consumes user activity data including email activity data indicative of time-stamped, detected user activity in an electronic mail (email) system, and generates the inferred value indicative of a working characteristic of the user; and
a control system that receives the inferred value and generates a control signal to control a controlled system based on the inferred value.

2. The computing system of claim 1 wherein the hierarchical generative model comprises:
hierarchical declarative variable connection logic configured with variables connected to one another through causal connections based on the email activity data.

3. The computing system of claim 2 wherein the hierarchical generative model comprises:
inference logic configured to receive the call for the inferred value, including an input variable, and to apply the input variable to the hierarchical declarative variable connection logic to identify the inferred value.

4. The computing system of claim 3 wherein the inference logic comprises:
probability generator logic configured to generate a probability distribution for values corresponding to the variable.

5. The computing system of claim 4 wherein the hierarchical generative model comprises a hierarchical Bayesian model.

6. The computing system of claim 3 wherein the hierarchical declarative variable connection logic is configured with a value for a working hour variable, indicative of whether a given hour is a working hour for the user, being dependent on a value for a usual working hour variable, indicative of whether the given hour is usually a working hour for the user, and a value for an exceptional day variable, indicative of whether a given day is a working day for the user.

7. The computing system of claim 6 wherein the hierarchical declarative variable connection logic is configured with the value for the usual working hour variable being dependent on a value for an hour of day variable, indicative of a particular hour of a day corresponding to the given hour, and a value for a day of week variable, indicative of a particular day of week corresponding to the given day.

8. The computing system of claim 7 wherein the hierarchical declarative variable connection logic is configured with a value for a meeting variable being dependent on the value for the working hour variable and having an expected email activity rate indicative of a rate at which the user performs activities in the email system when the user is attending a meeting.

9. The computing system of claim 7 wherein the hierarchical declarative variable connection logic is configured with a value for a working variable being dependent on the value for the working hour variable and having an expected email activity rate indicative of a rate at which the user performs activities in the email system when the user is working.

10. The computing system of claim 7 wherein the hierarchical declarative variable connection logic is configured with a value for a distracted variable being dependent on the value for the working hour variable and having an expected email activity rate indicative of a rate at which the user performs activities in the email system when the user is distracted.

11. The computing system of claim 7 wherein the inference logic comprises:
data merging logic configured to combine the email activity data with other activity data from another source to generate the inferred value.

12. The computing system of claim 1 and further comprising:
data cleaning logic configured to receive time-stamped detected activity data indicative of user activity in a plurality of different systems and store the time-stamped detected activity data in a data store, for access by the hierarchical generative model.

13. The computing system of claim 12 wherein the data cleaning logic is configured to access the hierarchical generative model to identify a less reliable time period during which the time-stamped detected activity data is less reliable in representing a user activity pattern than at other time periods and to remove any time-stamped detected activity data, having a time stamp corresponding to the less reliable time period, from access by the hierarchical generative model.

14. A computer implemented method, comprising:
receiving a call for an inferred value of a variable, at a hierarchical generative model;
generating the inferred value, indicative of a working characteristic of a user, by accessing inference logic in the hierarchical generative model that consumes user activity data including email activity data indicative of time-stamped, detected user activity in an electronic mail (email) system; and
generating a control signal to control a controlled system based on the inferred value.

15. The computer implemented method of claim 14 and further comprising:
receiving time-stamped detected activity data indicative of user activity in a plurality of different systems;
storing the time-stamped detected activity data in a data store, for access by the hierarchical generative model.

16. The computer implemented method of claim 15 and further comprising;
accessing the hierarchical generative model to identify a less reliable time period during which the time-stamped detected activity data is less reliable in representing a user activity pattern than at other time periods; and
removing any time-stamped detected activity data, having a time stamp corresponding to the less reliable time period, from access by the hierarchical generative model.

17. The computer implemented method of claim 14 wherein receiving the call comprises receiving the call for the inferred value, including an input variable, and wherein accessing the inference logic in the hierarchical generative model comprises applying the input variable to hierarchical declarative variable connection logic, that hierarchically connects variables to one another with causal connections, to identify the inferred value.

18. The computer implemented method of claim 17 wherein generating the inferred value comprises:
generating a probability corresponding to the inferred value.

19. A computing system, comprising:
a hierarchical generative model that receives a call for an inferred value and accesses inference logic that consumes user activity data including email activity data indicative of time-stamped, detected user activity in an electronic mail (email) system, and generates the inferred value indicative of a working characteristic of the user;
data cleaning logic configured to receive time-stamped detected activity data indicative of user activity in a plurality of different systems and store the time-stamped detected activity data in a data store, for access by the hierarchical generative model and to access the hierarchical generative model to identify a less reliable time period during which the time-stamped detected activity data is less reliable in representing a user activity pattern than at other time periods and to remove any time-stamped detected activity data, having a time stamp corresponding to the less reliable time period, from access by the hierarchical generative model; and
a control system that receives the inferred value and generates a control signal to control a controlled system based on the inferred value.

20. The computing system of claim 19 wherein the hierarchical generative model comprises a hierarchical Bayesian model.
